(19) United States
(12) Patent Application Publication
(10) Pub. No.: US 2023/0165223 A1
(43) Pub. Date: Jun. 1, 2023

(54) EGG HATCHING INCUBATOR HAVING REDUCED OPERATIONAL NOISE

(71) Applicant: N.R SOOS TECHNOLOGY LTD., Kaukab Abu al-Hija (IL)

(72) Inventor: Gadi Itzhak DEMER, Kibutz Dvir (IL)

(21) Appl. No.: 17/920,353

(22) PCT Filed: Apr. 22, 2021
(86) PCT No.: PCT/IL2021/050461

§ 371 Date: Oct. 20, 2022

Related U.S. Application Data
(60) Provisional application No. 63/014,897, filed on Apr. 24, 2020.

(51) Int. Cl. A01K 41/02; A01K 41/06; A61D 19/00; G10K 11/178

(52) U.S. Cl. CPC A01K 41/023; A01K 41/06; A61D 19/00; G10K 11/178

(57) ABSTRACT

Provided herein are egg hatching incubators having a reduced operational noise. In particular, provided are egg hatching incubators configured for affecting or promoting the sex of egg embryos using soundwaves at specific frequencies, wherein the operational noise of the incubator does not interfere with the transmitted soundwaves. Further provided are systems including the incubators and methods of using the same.

### FIELD OF THE INVENTION

Embodiments of the disclosure relate to egg hatching incubators with reduced operational noise, in particular to egg hatching incubators configured for determining or affecting the sex of egg embryos using soundwaves, wherein the operational noise of the incubators does not interfere with the transmitted soundwaves.

### BACKGROUND OF THE INVENTION

In animal production markets, such as, the poultry market, the ability to control or affect the sex of animals may enhance production, efficiency of production, waste and/or animal welfare.

For example, in egg laying operations only hens or females are desired, whereas the chicken meat market prefers male chickens.

Accordingly, when a flock of birds is born, only chicks with the desired sex are retained, and the other sex are euthanized or otherwise disposed. Because males and females are born at an approximate 50/50 sex ratio, approximately half of all avian born at such operations are thus lost resulting in large waste, low production efficiency and ethical implications.

Several methods for promoting the production of female or male embryos in eggs have been described, including, for example, illumination, soundwaves (for example, for promoting female embryos using soundwave at a certain range of frequencies to the fertilized eggs), and administration of agents.

There is thus a need in the art for improved incubators for hatching of fertilized eggs, in particular when using soundwaves for promoting production of a certain sex in the embryos, whereby the incubators have very low to no operational noise inside the incubator, so as to prevent interference with the transmitted soundwaves.

### SUMMARY OF THE INVENTION

The following embodiments and aspects thereof are described and illustrated in conjunction with systems, tools and methods which are meant to be exemplary and illustrative, not limiting in scope.

According to some embodiments, provided herein are advantageous egg-hatching incubators for promoting, controlling or affecting sex of egg embryos using specific soundwaves wherein the advantageous incubators exhibit very low or even devoid of operational noise inside the incubators, to thereby improve the effect of the specific soundwaves on the fertilized eggs which are incubated within the incubator. In some embodiments, the operational noise is below a predetermined threshold.

According to some embodiments, the incubators disclosed herein allow improved control/influence on the sex of embryos in eggs in order to promote the development of embryos of a selected sex. In some embodiments, the incubators, systems including the incubators and methods of utilizing the incubators rely on the application of soundwaves having selected/specific frequencies to incubated eggs in order to influence the sex ratios of embryos development in the fertilized eggs. According to some embodiments, the incubator is configured to emit or allow the transmission of soundwaves (for example, by a transmitter unit) at specific frequencies (“promoting soundwaves”), which are effective in promoting the sex of the embryos, while having reduced/minimal or are even devoid of operational noise/sound (which may interfere with the promoting soundwaves) in the interior region/cavity of the incubator. In some embodiments, as detailed herein, the eggs may be held by designated trays or sets of trays such that the promoting soundwaves can reach the eggs in the trays without interference, and wherein operational noise in the incubator is kept at minimum (below a required threshold), to thereby increase the efficiency of the promoting soundwaves in promoting/affecting/influencing the sex of the embryos.

According to some embodiments, there is provided an incubator for sex-controlled hatching of fertilized eggs. The incubator is advantageously essentially devoid of internal operational noise (or having internal operational noise below a threshold), thereby enabling interference-free transmission of soundwaves which are capable of promoting the production of a desired sex in the embryos.

According to some embodiments, there is provided an incubator for hatching of fertilized eggs, the incubator includes a housing configured to contain therein at least one egg tray; and a closed circulation system (unit) which includes: at least one ventilation pipe, external to the housing, the ventilation pipe having an inlet configured to deliver air into the housing, and an outlet configured to receive air from the housing; a heater, positioned externally to the housing, the heater configured to heat air in the pipe to a predetermined temperature prior to delivery, such that the air delivered to the housing is an airconditioned air having a predetermined temperature; and a pump, positioned externally to the housing, the pump configured to ensure flow of air within the ventilation pipe such that air is delivered to the housing at a desired flow rate; wherein a noise level within the housing, produced by operation of the circulation system, is below about 90 decibel (dB).

In some embodiments, the incubator may further include an exhaust chimney configured to expel air from within the housing.

In some embodiments, the exhaust chimney is positioned on the roof of the housing.

In some embodiments, the incubator may further include an air channel including fresh air, and a conduit configured to deliver the fresh air into the housing.

In some embodiments, the exhaust chimney and the air channel include dampers.

In some embodiments, the incubator may further include a controller configured to control the opening and/or closing of the damper.

In some embodiments, controlling the operation of the dampers include opening/closing the dampers essentially simultaneously, thereby causing an exchange of air within the housing.

In some embodiments, the outlet of the ventilation pipe is positioned on a roof of the housing and the inlet of the ventilation pipe is positioned in a lower part of a wall of the housing, such that the air enters the housing at a lower part thereof and exits the housing through the outlet positioned on the roof thereof.

In some embodiments, the inlet and/or the outlet may be covered by an adjustable air vent grille.

In some embodiments, the incubator, may further include a soundwave transmitter configured to transmit soundwaves at a predetermined frequency during incubation of the fertilized eggs; wherein the soundwave is configured to influence the sex of embryos in the fertilized egg.

In some embodiments, the soundwave transmitter is configured to transmit soundwaves at a frequency ranging from about 100 Hz to about 2000 Hz, thereby promoting production of female embryos in the fertilized egg.

In some embodiments, the soundwave transmitted by the soundwave transmitter is unaffected by noise produced by the ventilation system.

In some embodiments, the controller is further configured to control the frequency of the soundwaves.

In some embodiments, the housing is devoid of an internal fan and/or heater.

In some embodiments, the circulation system includes at least two ventilation pipes.

In some embodiments, the walls of the housing are sound insulated, such that noise from outside the housing does not interfere with the transmitted soundwaves.

In some embodiments, the pump may include a noise cancellation mechanism configured to reduce noise produced by operation of the pump.

According to some embodiments, there is provided a system for hatching of fertilized eggs, the system includes the incubator as disclosed herein and at least one egg tray housed within the incubator.

According to some embodiments, the egg tray is movable within the incubator. In some embodiments, the location of the egg tray within the incubator may be changeably. In some embodiments, the egg tray is placed on or is a trolley or a cart. In some embodiments, the system includes a plurality of egg trays.

According to some embodiments, the fertilized eggs are avian eggs. In some embodiments, the fertilized eggs are chicken eggs.

According to some embodiments, the hatching system may further include one or more sensors configured to provide information regarding environmental parameters within or externally to the incubator. According to some embodiments, the environmental parameters may include such parameters as, but not limited to: temperature, noise, humidity, light, or any combination thereof.

According to some embodiments, the hatching system disclosed herein is configured to influence the sex of embryos in the fertilized eggs. In some embodiments, the hatching system disclosed herein is configured to promote formation of female embryos in the fertilized eggs.

More details and features of the current invention and its embodiments may be found in the description and the attached drawings.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE FIGURES

Examples illustrative of embodiments are described below with reference to figures attached hereto. Identical structures elements or parts that appear in more than one figure are generally labeled with the same number in all the figures in which they appear. Alternatively, elements or parts that appear in more than one figure may be labeled with different numbers in the different figures in which they appear. The dimensions of the components and features in the figures were chosen for convenience and clarity of presentation and are not necessarily shown to scale. The figures are listed below:

FIG. 1 schematically depicts a side view of an incubator having a ventilation pipe, which is external to the housing, according to some embodiments; and

FIG. 2 schematically depicts a perspective view of an incubator having more than one ventilation pipe, which is external to the housing, according to some embodiments.

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, disclosed herein is an advantageous incubator for promoting the development of female or male embryos in fertilized eggs by applying a soundwave to incubated fertilized eggs. In some embodiments, there is provided an incubator for hatching of fertilized eggs that is devoid of operational noise inside the incubator, or wherein the operational noise inside the incubator is below a predetermined threshold. In some embodiments, such an advantageous incubator is required in order to enable interference-free transmittal of soundwaves promoting production of a desired sex in the embryos.

As used herein the term “promoting soundwaves” is directed to soundwaves transmitted at specific frequency or range of frequencies that is configured to/capable of promoting or affecting sex of embryos of fertilized eggs. In some embodiments, the promoting soundwaves are produced by a sound wave transmitter. In some embodiments, the frequencies of the promoting soundwaves may range from about 100 Hz to about 2000 Hz, and any subranges thereof. In some embodiments, the promoting soundwaves are transmitted in the housing (interior cavity) of egg-hatching incubator, in which the fertilized eggs are incubated. In some embodiments, the promoting soundwaves may be provided at any designated timing, for any designated period of time. In some embodiments, the promoting soundwaves may be provided continuously or intermittently, according to a selected schedule.

As used herein, the term “incubator” is directed to an egg hatching incubator, which is configured to provide suitable conditions (such as, heat, humidity, sound) for fertilized eggs, for example to allow or promote hatching thereof. In some embodiments, the operational noise within the incubator (i.e., within the housing thereof) may be below a threshold. In some embodiments, the threshold is predetermined. In some embodiments, the threshold may be below about 90 dB, below about 85 dB, below about 70 dB, below about 60 dB, below about 50 dB. In some embodiments, when the operational noise is below a threshold, the effect of the promoting sound waves on affecting the sex of the embryos of the fertilized eggs is improved. In some embodiments, the temperature within the incubator may be about 37° C.-38° C. In some embodiments, the humidity within the incubator may be in the range of about 40%-80%.

The terms “determining”, “affecting”, “promoting”, “enhancing” the sex of egg embryos may interchangeably be used. The terms are directed to the effect of increasing the percentage of one sex of the embryos of fertilized eggs (i.e., increase the percentage of female embryos or male embryos). In some embodiments, as disclosed herein, the affecting is facilitated by transmission of promoting soundwaves to fertilized eggs in an incubator, wherein the incubator advantageously exhibits reduced operational noise within the incubator.

According to some embodiments, the eggs may be any type of avian eggs, including, for example, chicken eggs, duck eggs, quail eggs, turkey eggs, and the like.

According to some embodiments, the incubators disclosed herein may generally have a housing having opposing side walls, a roof and a floor, defining the boundaries of the incubator. In some embodiments, each two opposing walls may be essentially parallel thereto. In some embodiments, the incubator may have a door or opening allowing access to the internal space/cavity thereof.

According to some embodiments, at least one egg tray configured to hold fertilized eggs may be positioned within the incubator. In some embodiments, a plurality of egg trays may be placed within the incubator. In some embodiments, the egg trays may be movable, maneuverable, and may be placed on a cart or any other suitable carrier. In some embodiments, the position of the egg trays within the incubator may alternate (manually or automatically) during incubation.

According to some embodiments, the incubators disclosed herein have a closed circulation system (also referred to as closed circulation unit). In some embodiments, the closed circulation system may include at least one ventilation pipe (ventilation tunnel), which is external to the housing of the incubator. In some embodiments, the ventilation pipe has an inlet which is configured to deliver fluids (such as, air) into the housing of the incubator (cavity thereof), and an outlet which configured to receive fluids (such as, air) from the housing of the incubator. According to some embodiments, the inlet of the ventilation pipe may be in a lower part/portion/region of the side wall of the housing. In some embodiments, the outlet of the ventilation pipe may be located at an upper part/portion/region of the housing, for example, in the roof of the housing. According to some embodiments, the inlet and/or outlet may be covered by an adjustable filter or air vent grille. In some embodiments, the enables the entering of air-conditioned air to the housing (i.e., internal cavity of the incubator) and the outlet enables the exit of air, which has higher CO₂ content/concentration. In some embodiments, the ventilation pipe(s) allow providing homogenic air (in terms of, for example, oxygen concentration, CO₂ concentration, temperature and/or humidity) to inside the incubator (i.e., to the cavity of the incubator). In some embodiments, the diameter of the pipe may be in the range of, for example, 2-16 inch. For example, the diameter of the ventilation pipe may be about 8″.

According to some embodiments, the closed circulation system may further include a heater, which is positioned externally to the housing. In some embodiments, the heater is configured to heat air in the ventilation pipe to a predetermined temperature prior to delivery, such that the air which is delivered to the housing is an airconditioned air having a predetermined temperature, thereby providing air-conditioned air to the housing. In some embodiments, the air-conditioned-air may be at any desired temperature, in accordance with the incubated fertilized eggs, such as, for example, in the range of about 30-38° C. For example, the air-conditioned air is at a temperature of about 34° C.-38° C. For example, the air-conditioned air is at a temperature of about 37° C.-38° C. For example, the air-conditioned air may be at a temperature of about 37° C. In some embodiments, the heater may be a heater/cooler device, capable of heating or cooling air to thereby provide air a at a desired temperature.

According to some embodiments, the closed circulation system may further include a pump, which may be positioned externally to the housing. In some embodiments, the pump is configured to ensure flow of air within the ventilation pipe such that air is delivered to the housing at a desired flow rate. In some embodiments, the pump may be any type of pump, such as, electrical pump. In some embodiments, the pump includes a noise cancellation mechanism which is configured to reduce noise produced by operation thereof.

According to some embodiments, the closed circulation system may further optionally include a fan which may be positioned external to the housing of the incubator, wherein the fan may assist the air flow within the ventilation pipe.

According to some embodiments, the incubators disclosed herein may include one or more exhaust chimneys that are capable of expelling air from within the housing of the incubator. The chimney(s) may be located on any desired upper region/wall of the incubator, for example, on the roof of the incubator. In some embodiments, the chimney(s) may have a damper, a valve and/or or shutter which are configured to allow controlled exit/evacuation of CO₂-saturated air from within the housing of the incubator. In some embodiments, the diameter of the chimney may be in the range of, for example, 2-16 inch. For example, the diameter of the chimney may be about 8″.

According to some embodiments, the incubators disclosed herein may include one or more air channels that may be located externally to the housing, wherein the air channel(s) include fresh air configured for deliver into the housing. In some embodiments, each air channel may include a damper, a valve and/or a shutter configured to allow controlled delivery of fresh air from the air channel into the cavity of the incubator (i.e., into the housing).

According to some embodiments, the incubators disclosed herein may include or be associated with a control unit which is configured for controlling operation of the incubator in general, and in particular may control the opening or the closing of the damper/valve/shutter of the chimney(s) and/or the air channel(s). In some embodiments, the control unit may control the operation of the damper/valve/shutter of the exhaust chimney(s) and of the air channel(s) essentially simultaneously, thereby causing exchange of air within the housing of the incubator. In some embodiments, the control unit may activate/de-activate or otherwise control operational parameters of different components/elements of the incubator(s), including, for example, the components of the ventilation system, such as, pump, heater, fan of the ventilation system. In some embodiments, controlling components of the ventilation system may be performed so as to ensure an essential constant flow of air at a desired flow rate within the ventilation pipe such that air that is delivered to the housing may spread essentially evenly/homogenously within the housing. In some embodiments, the location of the egg tray(s) within the incubator may be correspond to the location of the ventilation pipe(s) or openings thereof. For example, an egg tray may be placed essentially between two ventilation pipes openings.

In some embodiments, the controller may include any type of hardware/software and may include one or more processors, memory units, user interface, and the like. In some embodiments, the controller may include or may couple to/associate with one or more sensors that may be located inside and/or externally to the housing. Such sensors may include, for example, but not limited to: temperature sensor, humidity sensor, acoustic sensor, light sensor, and the like, or any combination thereof. The sensor(s) may provide the controller with various related information, such as, environmental conditions (for example, noise, temperature, humidity, and the like). In some embodiments, the controller may operate automatically (for example, according to a schedule), semi-automatically or manually.

According to some embodiments, the incubator may further include a soundwave transmitter configured to transmit soundwaves (promoting sound waves) into and/or within the housing, such that the promoting soundwaves are capable of reaching the eggs placed/located within the housing, i.e., the eggs within the incubator are exposed are accessible to the promoting sound waves generated/transmitted by the soundwave transmitter. in some embodiments, the transmitter is configured to transmit soundwaves at a frequency ranging from about 100 Hz to about 2000 Hz. In some embodiments, the transmitted soundwave is unaffected by the noise of the external closed circulation system of the incubator. In some embodiments, the soundwave transmitter is in a form of a speaker configured to emit soundwaves at the desired frequency.

According to some embodiments, the control unit of the incubator may further be configured to control the operation of the sound wave transmitter, for example, by controlling the timing and/or frequency of the promoting soundwaves transmitted transmitter.

According to some embodiments, the control unit may be further configured to activate/de-activate components of the incubator, such as, heater/cooler/thermostat, humidifier, and the like, so as to ensure/maintain suitable conditions, such as, pre-determined temperature, humidity, and the like.

In some embodiments, the housing of the incubator may be devoid of internal heater, pump and/or fan.

In some embodiments, the walls of the housing may be sound insulated, such that noise from outside the housing does not interfere with the transmitted promoting soundwaves.

According to some embodiments, the noise level within the housing of the incubator, which is produced by operation of the circulation system, is below about 90 decibels. In some embodiments, in the absence of soundwave transmission (i.e., in the absence of promoting soundwaves), the noise level produced by operation of the circulation system, may be below about 90, 87, 85, 83, 81, 80, 78, 76, 74, 72, 70 or less decibels (dBs). In some embodiments, in the absence of soundwave transmission, the noise level produced by operation of the circulation system, may be below about 78 decibels. In some embodiments, in the absence of soundwave transmission, the noise level produced by operation of the circulation system, may be about one decibel.

According to some embodiments, utilizing the advantageous incubators disclosed herein, which allow transmission of promoting soundwaves at desired frequencies, while minimizing operational noise to below a desired threshold, the ratio of female embryos compared to male embryos is vastly increased.

According to some embodiments, there is thus provided an incubator for hatching of fertilized eggs, the incubator having a housing configured to contain therein at least one egg tray; and a closed circulation system which includes:

at least one ventilation pipe, external to the housing, the ventilation pipe having an inlet configured to deliver air into the housing of the incubator, and an outlet configured to receive air from the housing;

a heater, positioned externally to the housing, the heater configured to heat air in the pipe to a predetermined temperature prior to delivery, such that the air delivered to the housing is an airconditioned air having a predetermined temperature; and

a pump, positioned externally to the housing, the pump configured to ensure flow of air within the ventilation pipe such that air is delivered to the housing at a desired flow rate;

wherein a noise level within the housing, produced by operation of the circulation system, is below about 90 decibel. In some embodiments, in the absence of soundwave transmission, the noise level produced by operation of the circulation system, is below about 90, 87, 85, 83, 81, 80, 78, 76, 74, 72, 70 or less decibels. In some embodiments, in the absence of soundwave transmission, the noise level produced by operation of the circulation system, is below about 78 decibel. In some embodiments, in the absence of soundwave transmission, the noise level produced by operation of the circulation system, is about decibel. in some embodiments, the transmitter transmits sound waves at a frequency ranging from about 100 Hz to about 2000 Hz. In some embodiments, the transmitted soundwave is unaffected by the noise of the external closed circulation system described herein.

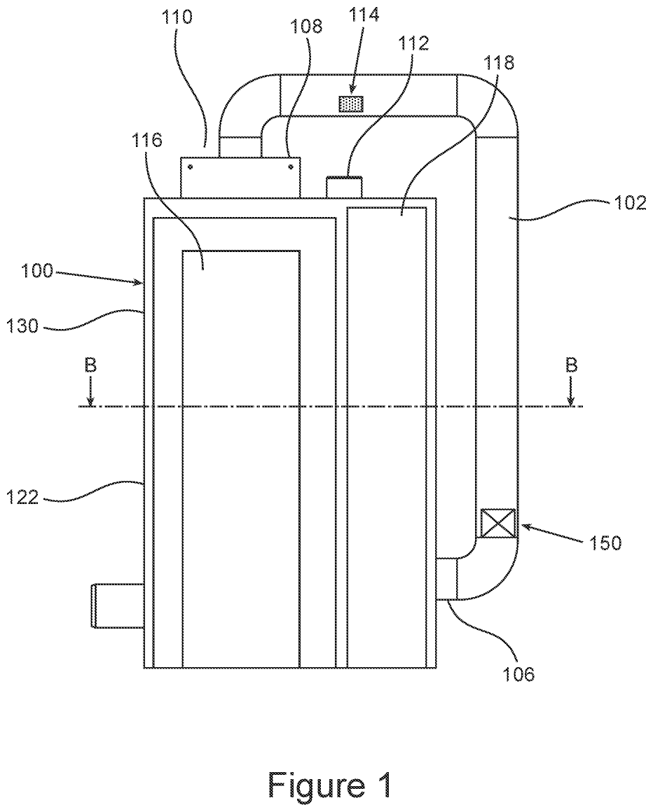

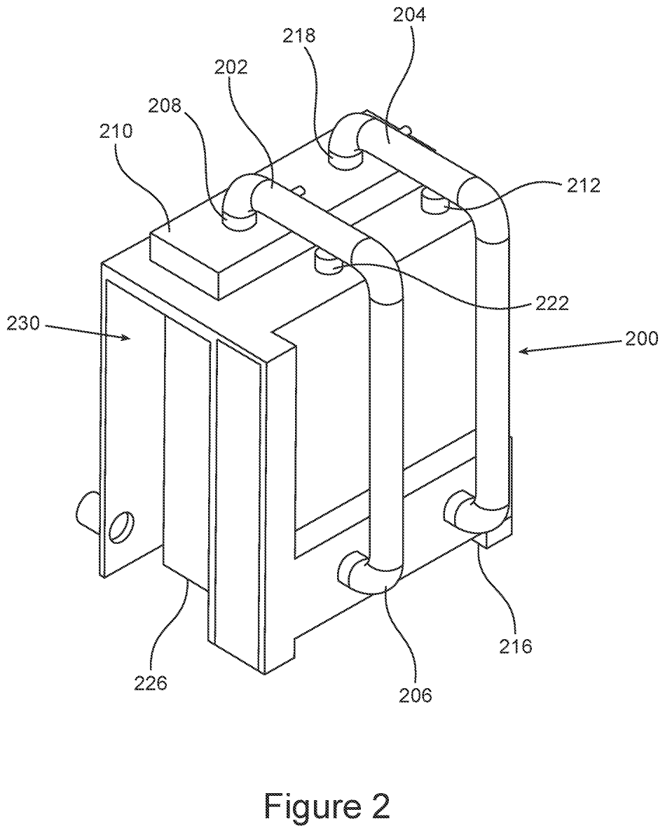

Throughout the following description, similar elements of different embodiments of the device are referenced by element numbers differing by integer multiples of 100. For example, an incubator of FIG. 1 is referenced by the number 102, and an incubator of FIG. 2, which corresponds to incubator 102 of FIG. 1, is referenced by the number 202.

Reference is now made to FIG. 1, which schematically depicts a perspective side view of an incubator 100 with reduced internal operation noise, according to some embodiments. As shown in FIG. 1, incubator 100 includes a housing 130 configured to contain therein at least one egg tray or egg trolley (cart) 116. Housing 130 includes a roof 110 and side walls 122. Incubator 100 further includes a closed circulation system having a ventilation tunnel or ventilation pipe 102, which is external to housing 130. The circulation system further includes a heater 114 positioned externally to the housing, the heater configured to heat air in ventilation pipe 102 to a predetermined temperature prior to delivery, such that the air delivered to housing 130 is airconditioned air having a predetermined temperature. The circulation system further includes and a pump 150 that is configured to ensure flow of air within the ventilation pipe such that air is delivered to the housing at a desired flow rate. In some embodiments, housing 130 also includes a fan (not shown) positioned external to housing 130, wherein the fan assists the air flow within ventilation tunnel/pipe 102.

In some embodiments the ventilation tunnel or pipe 102 has an inlet 106 in a lower part of side wall 122 of housing 130 and an outlet 108 at an upper part of housing 130, optionally in the roof 110 of housing 130. Inlet 106 and/or outlet 108 may be covered by an adjustable filter or air vent grille, such as grille 120. Inlet 106 enables the entering of air-conditioned air to housing 130 and outlet 108 enables the exit of air saturated with CO₂. In some embodiments, incubator 100 includes an exhaust chimney 112 (or more than one chimneys) that expels air from within housing 130. Chimney 112 may be located on roof 110 or elsewhere in the upper part of wall 122. Chimney 112 may comprise a damper (not shown) or a valve or shutter (not shown) configured to allow controlled exit of CO₂-saturated air from housing 130. In some embodiments, incubator 100 comprises an air channel (not shown) or more than one air channels, external to housing 130, which air channel includes fresh air configured for delivery to housing 130. The air channel may comprise a damper (not shown), a valve or shutter (not shown) configured to allow controlled delivery of fresh air from the air channel to housing 130. Housing 130 normally can hold/accommodate at least one egg tray/trolley (such as exemplary egg tray/trolley 116). Incubator 100 includes a control unit 118 for controlling the opening or the closing of the damper/valve or shutter of chimney 112 and/or the air channel not shown. Control unit 118 may control the operation of the damper/valve/shutter of exhaust chimney 112 and of the air channel (not shown) essentially simultaneously, thereby causing exchange of air within the housing 130. Control unit may activate/de-activate or otherwise control operational parameters of different components of incubator 100, such as, the pump (not shown) so as to ensure an essential constant flow of air at a desired flow rate within ventilation tunnel/pipe 102 such that air is delivered to the housing is spread essentially evenly within housing 130. According to some embodiments, incubator 100 further includes a sound wave transmitter configured to transmit soundwaves into and/or within housing 130. According to some embodiments, control unit 118 may be further configured to control the frequency of the soundwaves transmitted by the sound wave transmitter. According to some embodiments, control unit 118 may be further configured to activate/de-activate heater/cooler/thermostat, humidifier, etc. so as to ensure a pre-determined temperature, humidity, and the like.

Reference is now made to FIG. 2, which schematically depicts a perspective view of incubator 200 having more than one ventilation tunnels/pipes, according to some embodiments. Shown in FIG. 2, are two ventilation pipes 202 and 204, which are external to housing 230. Ventilation tunnels/pipes 202 and 204 may provide homogenic air (in terms of oxygen or CO₂ contents, temperature and or humidity) inside incubator 200. Ventilation pipe 202 has an inlet 206 in a lower location of incubator 200 and an outlet 208 at an upper location of the incubator which may be in the roof 210 of the incubator 200. Ventilation pipe 204 has an inlet 216 in a lower location of the incubator and an outlet 218 in an upper location of the incubator, which may be in the roof 210 of incubator 200. In some embodiments, incubator 200 contains one, two or more chimneys (in this figure two chimneys 212 and 222 are shown). In some embodiments, if there are more than one ventilation tunnels/pipes, the egg tray or trolley 226 may be placed essentially in the middle of ventilation tunnels/pipes 212 and 222.

According to some exemplary embodiments, the size of the housing may vary, thereby defining a variable internal cavity volume that may accommodate various types/sizes of egg trays, for example. In some embodiments, several incubators may operate in conjunction. In some embodiments, several incubators maybe functionally or physically associated and may thus share one or more resources, such as, for example, but not limited to: processing unit(s), circulation system components, and the like. In some embodiments, the incubator may be made of any suitable material. In some embodiments, the incubator may have one or more openings/doors at walls thereof.

According to some embodiments, there is provided a system for hatching of fertilized eggs, which includes the incubator(s) as disclosed herein and at least one egg tray housed within the incubator(s). In some embodiments, the system for hatching eggs allows to influence the sex of embryos in the fertilized eggs by utilizing promoting soundwaves at specific frequencies, and while maintaining low levels of operational noise. In some embodiments, the system for hatching eggs enables interference-free transmission of soundwaves which are capable of promoting the production of a desired sex in the embryos incubated within the incubator of the hatching system.

According to some embodiments, there is provide a method for determining the sex of fertilized eggs, the method includes incubating the eggs in the incubator disclosed herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof. According to some embodiments, the term “comprising” may be replaced by the term “consisting essentially of” or “consisting of”.

The term “about” refers to a reasonable variation from a stated amount that retains the ability to achieve one or more functional effect to substantially the same extent as the stated amount. The term may also refer herein to a value of plus or minus 10% of the stated value; or plus or minus 5%, or plus or minus 1%, or plus or minus 0.5%, or plus or minus 0.1%, or any percentage in between.

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

In the description and claims of the application, each of the words “comprise” “include” and “have”, and forms thereof, are not necessarily limited to members in a list with which the words may be associated.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-27. (canceled)

28. An incubator for hatching of fertilized eggs, the incubator comprising a housing configured to contain therein at least one egg tray; and
a closed circulation system comprising:
at least one ventilation pipe, external to the housing, the ventilation pipe comprising an inlet configured to deliver air into the housing, and an outlet configured to receive air from the housing;
a heater, positioned externally to the housing, the heater configured to heat air in the pipe to a predetermined temperature prior to delivery, such that the air delivered to the housing is an airconditioned air having a predetermined temperature; and
a pump, positioned externally to the housing, the pump configured to ensure flow of air within the ventilation pipe such that air is delivered to the housing at a desired flow rate;
wherein a noise level within the housing, produced by operation of the circulation system, is below about 90 decibel (dB).

29. The incubator of claim 28, further comprising an exhaust chimney configured to expel air from within the housing.

30. The incubator of claim 29 wherein the exhaust chimney is positioned on the roof of the housing.

31. The incubator of claim 30, further comprising an air channel comprising fresh air, and a conduit configured to deliver the fresh air into the housing.

32. The incubator of claim 31, wherein the exhaust chimney and the air channel comprise dampers.

33. The incubator of claim 32, further comprising a controller configured to control the opening and/or closing of the damper.

34. The incubator of claim 28, wherein the outlet of the ventilation pipe is positioned on a roof of the housing and wherein the inlet of the ventilation pipe is positioned in a lower part of a wall of the housing, such that the air enters the housing at a lower part thereof and exits the housing through the outlet positioned on the roof thereof.

35. The incubator of claim 28, wherein the inlet and/or the outlet is covered by an adjustable air vent grille.

36. The incubator of claim 28, further comprising a soundwave transmitter configured to transmit soundwaves at a predetermined frequency during incubation of the fertilized eggs; which soundwave is configured to influence the sex of embryos in the fertilized egg.

37. The incubator of claim 36, wherein the soundwave transmitter is configured to transmit soundwaves at a frequency ranging from about 100 Hz to about 2000 Hz, thereby promoting production of female embryos in the fertilized egg; wherein the soundwave transmitted by the soundwave transmitter is essentially unaffected by noise produced by the ventilation system.

38. The incubator of claim 36, wherein the controller is further configured to control the frequency of the soundwaves.

39. The incubator of claim 28, wherein the housing is devoid of an internal fan and/or heater.

40. The incubator of claim 28, wherein the circulation system comprises at least two ventilation pipes.

41. The incubator of claim 28, wherein walls of the housing are sound insulated, such that noise from outside the housing does not interfere with the transmitted soundwaves.

42. The incubator of claim 28, wherein the pump comprises a noise cancellation mechanism configured to reduce noise produced by operation of the pump.

43. The incubator of claim 28, configured to influence the sex of embryos in the fertilized eggs, by promoting formation of female embryos in the fertilized eggs.

44. A system for hatching of fertilized eggs, the system comprising:
the incubator of claim 28; and
at least one egg tray housed within the incubator.

45. The system according to claim 44, wherein the egg trays are movable within the incubator.

46. The system according to claim 44, further comprising one or more sensors configured to provide information regarding environmental parameters within or externally to the incubator.

47. The system according to claim 44, wherein the system is configured to influence the sex of embryos in the fertilized eggs, by promoting formation of female embryos in the fertilized eggs.
